(19) United States
(12) Patent Application Publication
(10) Pub. No.: US 2008/0050170 A1
(43) Pub. Date: Feb. 28, 2008

(54) Pistonless Apparatus for Dispensing Liquified Material

(76) Inventor: Steven J. Mondloch, Kaukauna, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/839,061

(22) Filed: Aug. 15, 2007

Related U.S. Application Data
(60) Provisional application No. 60/839,204, filed on Aug. 22, 2006.

(51) Int. Cl. B05C 17/005

(52) U.S. Cl. 401/187; 222/373

(57) ABSTRACT

An apparatus for dispensing liquified material includes a hollow storage body for holding a supply of liquified material within a flexible, collapsible bag located within the hollow storage body. A power supply head is connected to the bottom end of the hollow storage body. A liquified material supply head is connected to the top end of the storage body and has a liquified material passageway. An externally powered source is placed in communication with the power supply head to provide a compressive force on the bag holding the liquified material. The force is selectively applied to the bag so that liquified material is forced out of the bag in the hollow storage body through the liquified material passageway in the liquified material supply head.

### CROSS REFERENCE TO RELATED APPLICATIONS

This application claims priority from U.S. Provisional Patent Application Ser. No. 60/839,204, filed Aug. 22, 2006.

### FIELD OF THE INVENTION

This invention relates generally to the application of liquified material and, more particularly, pertains to the application of joint compound on drywall.

### BACKGROUND OF THE INVENTION

The assignee of this application is the owner of U.S. Pat. No. 5,863,146 issued Jan. 26, 1999 entitled Apparatus For Applying Liquified Material. This patent discloses an apparatus for applying liquefied material such as joint compound, using an externally powered source, preferably compressed air. The preferred apparatus has a hollow tubular storage body that is connected to a supply of compressed air, and a movable piston or plunger positioned within the hollow tubular storage body. The plunger has a pair of rubber seals that contact the inner wall of the storage body. A supply of joint compound is inserted into the storage body on the side of the piston or plunger opposite the side of the plunger that can be exposed to pressurized air. Pressurized air can be supplied by the user against the plunger to push the supply of joint compound out of the storage body through a mud supply head. An applicator tip is connected to the mud supply head and can be connected to either a flat joint attachment or a corner joint attachment for applying joint compound over a dry wall joint provided with mudless tape or mesh.

Although this apparatus continues to operate in a satisfactory manner with quality results, it is desirable to provide an alternative dispenser design that does not require the movable piston or plunger used inside the storage body.

### SUMMARY OF THE INVENTION

This application relates to an apparatus for dispensing liquified material. The apparatus includes a hollow storage body for holding a supply of liquified material within a flexible, collapsible bag located within the hollow storage body. The hollow storage body extends along a longitudinal axis and has a top end and a bottom end. A power supply head is connected to the bottom end of the hollow storage body. A supply head having a passageway is connected to the top end of the storage body. An externally powered source is placed in communication with the power supply head to provide a compressive force on the bag holding the liquified material. The force is selectively applied to the bag so that the liquified material is forced out of the bag in the hollow storage body through the liquified material passageway in the supply head.

The bag has a closed end located adjacent the power supply head and an open end located at the top end of the hollow storage body. The supply head has a fill valve for receiving a supply of liquified material that is delivered into the open end of the bag. In a preferred embodiment, an elongated standpipe has a bottom end located adjacent the power supply head, and a top end connected to the supply head. The standpipe is surrounded by the bag and is provided with perforations whereby a source of liquified material is fed to the supply head and the standpipe through the perforations and into the bag.

In another aspect of the invention, an apparatus is provided for supplying joint compound to be applied over a joint between sections of wallboard. The apparatus includes a hollow storage body for holding a supply of joint compound within a flexible, collapsible bag located within the hollow storage body. The hollow storage body extends along a longitudinal axis and has a top end and a bottom end. A power supply head is connected to the bottom end of the hollow storage body. A mud supply head is connected to the top end of the storage body, and has a joint compound passageway. An externally powered source is placed in communication with the power supply head to provide a compressive force on the bag holding the joint compound. The force is selectively applied to the bag so that the joint compound is forced out of the bag in the hollow storage body through the joint compound passageway in the mud supply head.

Various other objects, features and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an elevational view of an apparatus for dispensing liquified material in accordance with the present invention;

FIG. 2 is a perspective view of FIG. 1 with certain parts broken away to show internal structures;

FIG. 3 is an exploded perspective view showing the removable mud supply head of the apparatus shown in FIG. 2;

FIG. 4 is an exploded perspective view showing the removable power supply head of the apparatus shown in FIG. 2; and

FIG. 5 is a view like FIG. 1 showing an alternative embodiment of the present invention.

### DETAILED DESCRIPTION OF THE INVENTION

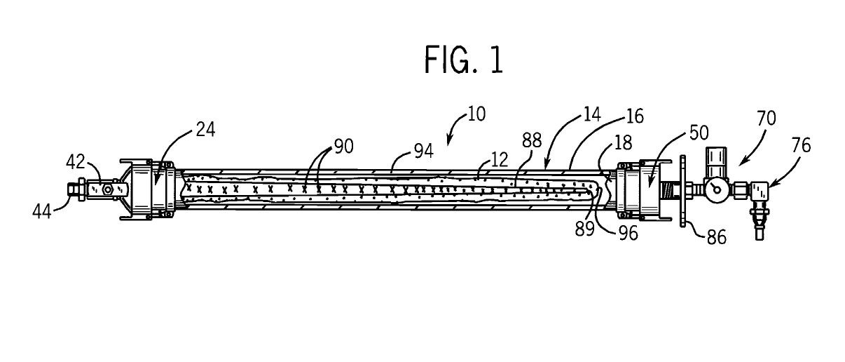

Referring now to the drawings, FIGS. 1-4 show one embodiment of an apparatus 10 for dispensing liquified material 12. In the drawings, the liquified material is preferably a joint compound or “mud” which is generally applied over adhesive-backed tape or mesh placed over drywall joints. However, it should be understood that the term liquified material also includes but is not limited to, plaster, adhesive, paint, and other semi-viscous materials as well as water.

The dispensing apparatus 10 includes a hollow storage body 14 that extends lengthwise along a longitudinal axis. The storage body 14 includes a cylindrical outer wall 16 surrounding and defining an internal open area 18. The outer wall 16 terminates at an open bottom end 20 and an open top end 22. Both the bottom and top ends 20, 22 have a circular cross section.

A mud supply head 24 is removably connected to the top end 22 of storage body 14. The mud supply head 24 has a generally cylindrical mounting portion 26 with an outer diameter sized slightly smaller than the internal diameter of top end 22 so that the mounting portion 26 can be positioned within top end 22 of storage body 14. A rubber seal 28 surrounds the outer diameter of mounting portion 26 and interacts with the inner surface of storage body 14 to provide an air and liquid-tight seal.

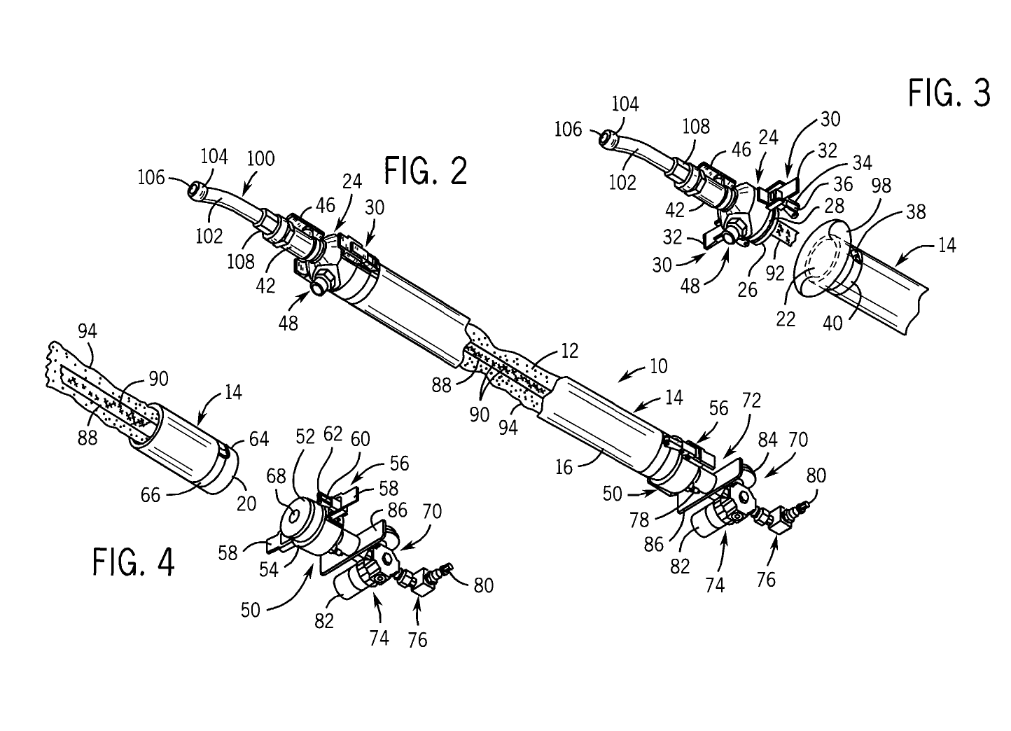

A pair of latches 30 is securely connected to the mud supply head 24. Each latch 30 contains an actuator handle 32 pivotally connected to an attachment body 34 having a rod 36. A pair of corresponding catch members 38 is securely attached to a metal band 40 encircling the storage body 14. When the mud supply head 24 is mounted on the top end 22 of the storage body 14, the rod 36 of each latch 30 is positioned behind one of the catch members 38. With the rod 36 in place, the actuator handle 32 is moved from an unlatched position of FIG. 3 to a latched position shown in FIG. 2 so as to secure the mud supply head 24 to the top end 22 of storage body 14. The mud supply head 24 is formed internally with a liquified material or joint compound passageway (not shown) which provides communication between the mud supply head 24 and the open area 18 of the storage body 14.

A shut-off valve 42 is threadedly attached to an upper end of the mud supply head 24. The shut-off valve 42 has an internal passageway (not shown) that allows liquid or joint compound to pass through the valve 42 and out of an externally threaded connector and outlet 44 (FIG. 1) when valve 42 is open. The internal passageway of shut-off valve 42 is preferably in axial alignment with the joint compound passageway in mud supply head 24. The shut-off valve 42 has a handle 46 to provide opening and closing of the valve 42. A one-way fill valve 48 is mounted on the mud supply head 24. Joint compound or other liquid is pumped out of a supply container and enters the fill valve 48 for delivery to the passageway formed in the mud supply head 24.

A power supply head 50 is removably connected to the bottom end 20 of storage body 14. The power supply head 50 has a generally cylindrical mounting portion 52 having an outer diameter slightly smaller than the internal diameter of the open bottom end 20 of the storage body 14 so that the mounting portion 52 can be positioned therein. A rubber seal 54 surrounds the outer diameter of mounting portion 52 and interacts with the inner surface of the storage body 14 at bottom end 20 to form a liquid and air-tight seal. A second pair of latches 56 (identical to latches 30 on the supply head 24) are securely connected to the power supply head 50. The latches 56 have an actuator handle 58, an attachment body 60 and a rod 62. A pair of catch members 64 are securely joined to a metal band 66 surrounding the outer diameter of storage body 14 at a location spaced longitudinally from bottom end 20. The pair of latches 56 operates in an identical fashion to the pair of latches 30 on mud supply head 24. The power supply head 50 has a centrally located air passageway 68 that provides communication between the open area 18 of the storage body 14 and an outer face of head 50.

As seen in FIG. 2, an air supply control assembly 70 is attached to the power supply head 50. The air supply control assembly 70 includes an actuator 72, a pressure regulator 74, an air supply connector 76, and a pressure relief valve 78. The air supply connector 76 is connected to a source of compressed air, such as an air compressor, by a quick disconnect fitting 80 such as through an air hose. Air entering the fitting 80 flows through the air supply connector 76 until it reaches the pressure regulator 74. Pressure regulator 74 has an adjustment knob 82 and a read-out dial 84 for controlling and monitoring pressure from the source of compressed air. The actuator 72 includes a pivoting handle 86 which selectively controls the passage of compressed air into the power supply head 50 and the open area 18 of storage body 14.

In the embodiment shown in FIGS. 1-4, an elongated, metallic standpipe 88 is centrally located in the open area 18 of the storage body 14, and extends between the mud supply head 24 and the power supply head 50. The standpipe 88 has a closed, lower end 89 (FIG. 1) which lies adjacent to and is spaced from, but does not obstruct the air passageway 68 on power supply head 50. The standpipe 88 is formed lengthwise about its periphery with a plurality of throughholes or perforations 90. The standpipe 88 has an open upper end 92 (FIG. 3) which is inserted into the passageway formed in mud supply head 24. Joint compound or other liquid delivered via fill valve 48 is designed to flow through standpipe 88 and out of the peripheral perforations 90.

The standpipe 88 is surrounded by a flexible, collapsible bag 94 along substantially the entire length thereof. The bag 94 is provided to receive and contain joint compound or other liquid that is supplied through the perforations 90 of the standpipe 88. The bag 94 has a closed, lower end 96 that is spaced from and lies adjacent the passageway 68 of the power supply head 50 without obstructing the passageway 68. The closed, lower end 96 also lies adjacent to closed, lower end 89 of standpipe 88. The bag 94 has an open upper end 98 which is folded back over the open top end 22 of storage body 14 (as seen in FIG. 3) before mud supply head 24 with standpipe 88 is sealingly attached to the storage body 14.

Although not absolutely necessary, an applicator tip 100 (FIGS. 2-3) is removably attached to the connector and outlet 44 on shut-off valve 42 attached to mud supply head 24. The applicator tip 100 includes a hollow stem 102 and a universal mounting ball 104 provided with an outlet 106. The stem 102 has a connector 108 that is screwthreaded on to the connector and outlet 44 of mud supply head 24. The applicator top 100 defines a passageway that is in alignment with the internal passageway and shut-off valve 42. In this manner, there is communication between the storage body 14 and the outlet 106. The mounting ball 104 facilitates connection between the applicator tip 100 and a variety of conventional and nonconventional attachments.

In use, the flexible, collapsible bag 94 is installed inside the storage body 14 such that the open upper end 98 is folded back over top end 22 of storage body as depicted in FIG. 3. Mud supply head 24 with attached standpipe 88 is then attached onto the top end 22 of storage body 14 such that the perforated standpipe extends into the bag 94 after which the power supply head 50 is latched to the bottom end 20 of storage body 14 as shown in FIG. 1. It should be appreciated that the outer diameter of standpipe 88 is smaller than the inner diameter of storage body 14. Once the mud supply head 24 and the power supply head 50 are attached, the air supply connector 76 is connected to a portable compressor or any other suitable source of compressed air.

To fill the bag 94 via the standpipe 88, the shut-off valve 42 is closed by rotating handle 46. With the shut-off valve 42 closed, an external pump is used to pump joint compound or other liquid from a supply container. The joint compound 12 or other liquid flows through the mud supply head 24 into the standpipe 88 and bag 94 until the bag 94 is full over substantially the entire length of the storage body 14. Filling may be observed through the outer wall 16 of the storage body 14 which is typically light-transmissive or translucent. The pump is then disconnected from the fill valve 48 and the shut-off valve 42 is reopened.

With the bag 94 completely or even partially filled, the user can proceed to apply or dispense joint compound or liquid as needed. To do this, the user pivots actuator handle 86 which delivers pressurized air through air passageway 68 in power supply head 50. Pressurized air uniformly fills the open area 18 of storage body 14 along its entire length, and provides a compressive force along the entire outside surface of bag 94 holding the joint compound 12 or other liquid. The pressurized air causes the joint compound 12 or other liquid to be pushed back into the standpipe 88 via perforations 90, and transferred to the mud supply head 24. With shut-off valve 42 open, joint compound 12 or other liquid flows through shut-off valve 42 open, and exits either through outlet 44 (FIG. 1) or, if equipped with applicator tip 100 (FIGS. 2-3), through mounting ball outlet 106. The amount of joint compound 12 or liquid dispensed can be regulated by having the user adjust the air pressure by rotating adjustment knob 82 on pressure regulator 74.

When the user wishes to cease applying or dispensing joint compound 12 or other liquid, actuator handle 86 is released, and the supply of pressurized air is cut-off to power supply head 50. When the entire supply of joint compound 12 or other liquid in bag 94 is exhausted, the bag 94 can be filled again using the fill valve 48. If desired, the mud supply head 32 can be unlatched from the top end 22 of the storage body 14 and the bag 94 can be disposed of and replaced before refilling.

In the event it is desired to clean the apparatus 10, a supply of water can be connected to and supplied to the fill valve 48 using the filling process set forth above. Then, pressurized air can be utilized as detailed above to force the water in bag 94 back through the perforated standpipe 88 and mud supply head 24 with or without applicator tip 100. In this manner, the apparatus 10 provides a source of pressurized water useful in cleaning the device.

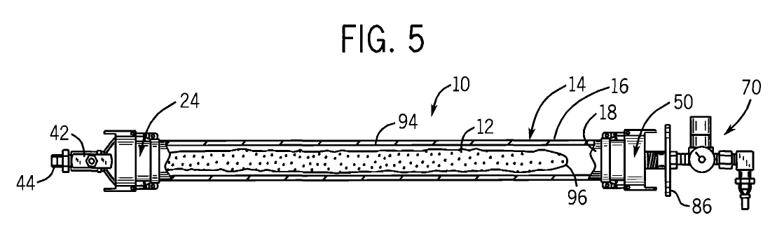

FIG. 5 illustrates an alternative embodiment of the invention which is similar to the embodiment of FIGS. 1-4, but does not require a standpipe 88. Here, joint compound 12 or other liquid is delivered via fill valve 48 directly into bag 94. Pressurized air acting upon outside of bag 94 will force the joint compound 12 or other liquid out of bag 94 and into mud supply 24 in the same manner as described above.

In the embodiments of FIG. 1-5, it should be understood that it may be desirable to fix the closed lower end 96 of bag 94 to the inner surface of storage body 14 so that it does not obstruct the pressurized air flow out of power supply head 50. Similarly, it may also be desirable to provide the upper end of bag 94 with a ring or other retaining device that attaches the bag 94 to the inside surface of the storage body 14. Such a device would prevent collapse of the bag 94 at the upper end thereof so that outgoing flow of joint compound 12 or other liquid is not restricted.

The present invention thus provides an externally powered apparatus for selectively dispensing liquid material, such as joint compound, from a storage body without the need for a movable plunger or piston inside the storage body.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

I claim:

1. An apparatus for dispensing liquified material, the apparatus comprising:
a hollow storage body for holding a supply of liquified material within a flexible, collapsible bag located within the hollow storage body, the hollow storage body extending along a longitudinal axis and having a top end and bottom end;
a power supply head connected to the bottom end of the hollow storage body;
a liquified material supply head connected to the top end of the storage body, the liquified material supply head having a liquified material passageway; and
an externally powered source in communication with the power supply head that provides a compressive force on the bag holding the liquified material, the force being selectively applied to the bag so that liquified material is forced out of the bag in the hollow storage body through the liquified material passageway in the liquified material supply head.

2. The apparatus of claim 1, wherein the bag has a closed end located adjacent the power supply head, and an open end located at the top end of the hollow storage body.

3. The apparatus of claim 2, including an elongated standpipe having a bottom end located adjacent the power supply head, and a top end connected to the liquid material supply head, the standpipe being surrounded by the bag and being provided with perforations whereby a source of liquified material is fed to the liquified material supply head and the standpipe through the perforations and into the bag.

4. The apparatus of claim 2, wherein the liquified material supply head has a fill valve for receiving a supply of liquefied material that is delivered into the open end of the bag.

5. The apparatus of claim 1, wherein the liquified material is joint compound.

6. An apparatus for supplying joint compound to be applied over a joint between sections of wallboard, the apparatus comprising:
a hollow storage body for holding a supply of joint compound within a flexible collapsible bag located within the hollow storage body, the hollow storage body extending along a longitudinal axis and having a top end and a bottom end;
a power supply head connected to the bottom end of the hollow storage body;
a mud supply head connected to the top end of the storage body, the mud supply head having a joint compound passageway; and
an externally powered source in communication with the power supply head that provides a compressive force on the bag holding the joint compound, the force being selectively applied to the bag so that the joint compound is forced out of the bag in the hollow storage body through the joint compound passageway in the mud supply head.
